(19) United States
(12) Patent Application Publication
(10) Pub. No.: US 2006/0228537 A1
(43) Pub. Date: Oct. 12, 2006

(54) Multi-layered gliding board comprising a polyethylene and ethylene vinyl acetate copolymer foam layer and an ethylene based octene plastomer film layer

(76) Inventor: Kwong Kee Cheung, New Territories (HK)

Correspondence Address: JACOBSON HOLMAN PLLC, 400 SEVENTH STREET N.W., SUITE 600, WASHINGTON, DC, 20004, US

(21) Appl. No.: 11/103,554

(22) Filed: Apr. 12, 2005

(51) Int. Cl. B32B 3/26; B32B 9/00

(52) U.S. Cl. 428/304.4; 428/318.4

(57) ABSTRACT

The invention relates to multi-layered laminated foam gliders with improved bonding characteristics and surface smoothness which can be used as a bodyboard, a snow sled or other gliding boards. In general, the foam gliders are multi-layered structure of polymer foam and polymer film, comprising a polyethylene and ethylene vinyl acetate copolymer foam sheet, an intermediate polymer film layer of ethylene based octene plastomer and a polyolefin film layer. The polyolefin film layer may include a graphic image. The structure provides improved graphic image definition with a smooth texture on the graphic imprinted polyolefin film surface and the intermediate polymer film layer improves bond strength between polyolefin film layer and polyethylene and ethylene vinyl acetate copolymer foam sheet. A method of continuous fabrication is also disclosed.

### FIELD OF THE INVENTION

This invention relates to foam gliders for recreational use and, more particularly, to a laminated sports board with improved bonding characteristics and surface smoothness. The gliding board can be used as a bodyboard, a snow sled, a grass gliding board, a sand gliding board or other gliding boards for recreational purpose.

### BACKGROUND OF THE INVENTION

A bodyboard or a snow sled made of polyethylene foam is typically composed of a number of polyethylene foam and polyethylene film layers that are laminated together by some conventional laminating processes. One conventional process is by heating the layers and the heated surfaces are immediately pressed and fused together by a pair of nip rollers. This laminating process is typically applied for bonding between a polyethylene foam layer to another polyethylene foam layer. Another conventional process of lamination typically applied for bonding between a polyethylene film layer and a polyethylene foam layer is to apply heat to the film layer with a heated nip roller on the film side and a normal nip roller on the foam side, where the heated nip roller generally contains an engraved pattern of convex and concave area for better heat transfer. The resulting polyethylene film/foam laminate is then often heat laminated onto a standard foam core.

Both of these laminating processes form a bonding between the two layers by localized collapse and fusion of foam cells on the surface of the respective layers. In order to acquire a good bonding between the two layers, the fusion temperature of polymeric material on the surface of the respective layers have to be within a very narrow temperature range. Otherwise inadequate bonding may result because the surface material on one layer has not heat up to the fusion state. If a higher heating temperature is applied to both surfaces of the layers, excessive melting of the surface material on the layer with lower fusion temperature may occur. Accordingly, there is need to provide a lamination method with improved bond strength to bond two polymer foam layers with difference fusion temperature caused by difference in polymeric material or density.

One limitation of the film lamination method using heated nip roller is that the process often uses mirco-cellular high density foam sheets to improve adhesion between the film and foam layers. Because the standard foam core does not have a perfectly planar surface, bonding between the film and foam core is limited to the apexes of the cells on the surface of the foam core. Therefore the points of bonding are not uniform and inadequate across the bonding surfaces. The micro-cellular foam sheet contains smaller peaks and valleys and the separation between the peaks is closer. As a result, the surface area of contact between the film and foam sheet is increased. However the contact points are still localized to the apexes of the cells on the surface of the foam sheet. This kind of structure is still prone to delamination by mechanical contact forces, the effect of heat, and by the effect of water. Therefore it is desirable to provide a lamination method with improved bonding between film and foam layers.

In addition, the film lamination method generally cannot use a flat roller as the heated nip roller for laminating a polyethylene film to a polyethylene foam sheet because the heat transfer rate is too low to bring the foam layer underneath the film layer to the required fusion temperature. A higher temperature employed by the heated nip roller can cause undesirable shrinkage of the film layer. In the case of the heated nip roller having an engraved pattern of convex and concave area, heat transfer rate is higher at the contact area that protrude from the engraved roller. As a result, heat bond between the polyethylene film/foam layers occurs at those localized contact area.

A traditional gliding board made of polyethylene foam typically contains a printed image on the film layer which is generally laminated onto the top deck of the board for decoration purpose. Conventionally a polyethylene film with a printed image is generally laminated onto the board with a convex and concave pattern due to the limitation of the film lamination method using heated nip roller as described. Even though a high density polyethylene foam sheet is normally applied to bond with the polyethylene graphic film, the resulting graphic image having convex and concave pattern have inferior image definition compared with a graphic image having a smooth surface. It would be advantageous to provide a system for applying sharp, distinct and wear-resistant graphics to a polyethylene foam core with a smooth texture on the graphic film surface.

It is well-known that polymer foam sheet having a very small cell structure can improve the surface smoothness of polymer film bonded to the foam sheet. One common polymer foam with very small cell structure is polyethylene and ethylene vinyl acetate copolymer foam. However, polyethylene and ethylene vinyl acetate copolymer has significant higher fusion temperature than polyethylene. As a result, a higher temperature is required and may cause undesirable shrinkage of the polyethylene film or foam layer if using conventional lamination method. Accordingly, there is a need for a thermally laminated foam board with improved bonding characteristics between a polyethylene and an ethylene vinyl acetate copolymer foam layer and a polyethylene foam or polyethylene film layer.

### SUMMARY OF THE INVENTION

The present invention provides a method to produce a polyethylene foam core glider with improved smoothness on the outer film surface. The present invention, briefly summarized, in one embodiment discloses an improved foam glider comprising an elongated expanded polyethylene foam core 23 having a core thickness and a top, bottom, side, front and back surfaces, a first polyolefin film 11 having an outer surface 10 and an inner surface 12, a polyethylene and ethylene vinyl acetate copolymer foam layer 17 having an outer 16 and inner surfaces 18, a first intermediate polymer film layer of ethylene based octene plastaomer 14 bonded on its outer surface 13 to the inner surface 12 of the polyolefin film and bonded on its inner surface 15 to the outer surface 16 of the foam layer 17, a second intermediate polymer film layer of ethylene based octene plastomer 20 bonded on its outer surface 19 to the inner surface 18 of the foam layer 17 and bonded on its inner surface to top, side, front and back surfaces of the core 23, and a polyethylene film 26 bonded on its inner surface 25 to the bottom surface 24 of the core 23. The polyolefin film may comprise a polyethylene, a polypropylene polymer or a blend of polyethylene with about 1 to 10% ethylene vinyl acetate. The polyolefin film may include a graphic image printed on its inner surface. The first intermediate film layer may be thermally bonded to the polyolefin film and the foam layer. The second intermediate film layer may be thermally bonded to the core and the foam layer. The board may further comprise a graphically imprinted film layer 8 bonded to the outer surface 10 of the first film layer 11. The polyethylene film may comprise a low-density polyethylene, high density polyethylene, a blend of polyethylene with about 1% to 10% ethylene vinyl acetate and a blend of high-density polyethylene with about 10% to 40% low-density polyethylene.

Accordingly, the general object of the present invention is to provide a system for bonding a polyolefin film to a polyethylene and ethylene vinyl acetate copolymer foam layer with improved bond strength.

Another object is to provide a system for applying sharp, distinct and wear-resistant graphics to a polyethylene foam core with a smooth texture on the graphic film surface.

Another object is to provide an improved foam glider in which different polyolefin materials may be laminated together with improved bonding.

Another object is to provide an improved foam glider in which allows the layers of different polyolefin material or different density to be laminated together at lower and less exact temperature ranges.

### BRIEF DESCRIPTION OF DRAWINGS

FIG. 1 is a front view of the foam glider.

FIG. 2a is a perspective and partial sectional view of the first embodiment of the foam glider.

FIG. 2b is a perspective and partial sectional view of the second embodiment of the foam glider.

FIG. 3a is a schematic diagram showing the process by which a film layer is bonded to a foam layer.

FIG. 3b is a schematic diagram showing the process by which a polyolefin film layer is laminated to a polyethylene and ethylene vinyl acetate copolymer foam layer with an intermediate polymer film layer of the preferred embodiments.

FIG. 4 is a schematic diagram showing the process by which a laminated skin is heat laminated to a polyethylene foam core.

FIG. 5 is a cross-sectional view of intermediate polymer film layer between polyolefin film layer and polyethylene and ethylene vinyl acetate copolymer foam layer of the preferred embodiments.

FIG. 6 is a cross-sectional view of the partial structure of the first embodiment of the foam glider.

FIG. 7 is a cross-sectional view of the partial structure of the first embodiment of the foam glider.

FIG. 8 is a cross-sectional view of the partial structure of the second embodiment of the foam glider.

FIG. 9 is a cross-sectional view of the core structure of the embodiment of the foam glider.

FIG. 10 is a cross-sectional view of the core structure of the embodiment of the foam glider.

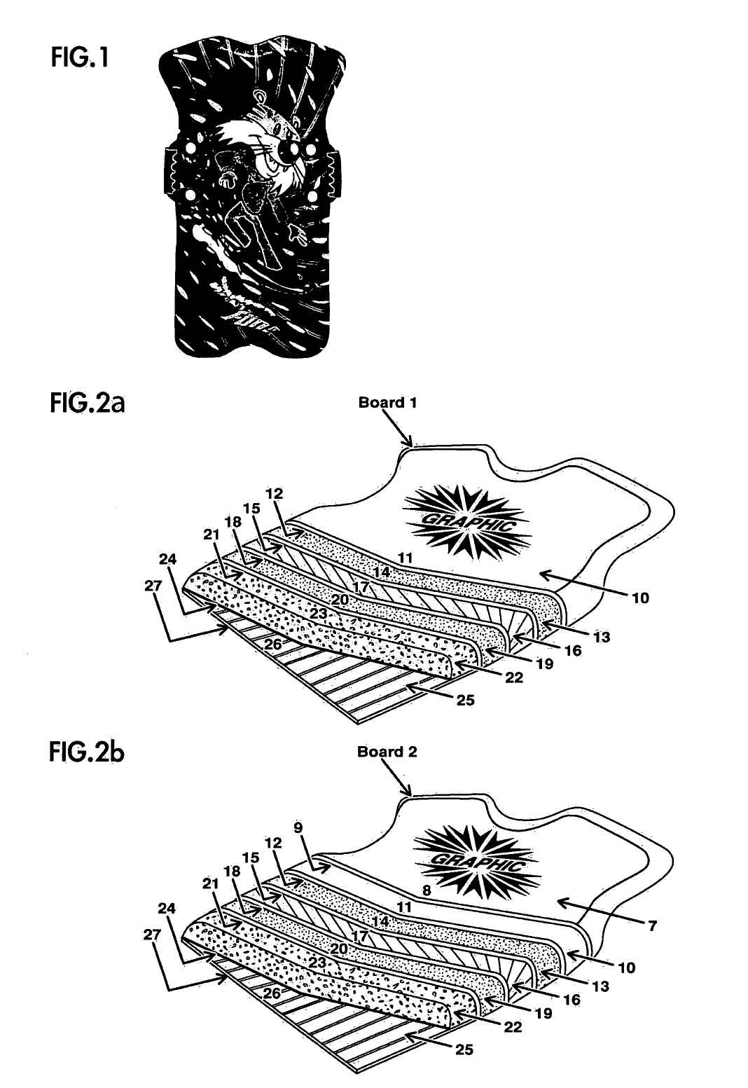

### DETAILED DESCRIPTION OF THE PREFERRED EMBODIMENTS

FIG. 2a illustrates the first embodiment of an improved foam glider which is generally indicated at Board 1. The foam glider is comprised of six layers laminated together. Top layer 11 is a graphically-imprinted polyolefin film. The reverse graphic images are imprinted on the inner surface 12 of layer 11 using any conventional process for printing on polyethylene or polypropylene, such as the corona printing process, in which an electrical discharge temporarily alters the surface structure of the film, allowing inks to adhere to the film. The top surface film layer 11 has a thickness of between 0.02 mm and 0.15 mm.

Layer 14 is an ethylene based octene plastomer. Layer 14 has a thickness of between 0.02 mm and 0.12 mm. Layer 14 has a density in the range of 0.84 to 0.94 g/cm³, and preferably a density of 0.88 g/cm³. The EXACT® octene plastomer provided by EXXONMOBILE, may be employed in the preferred embodiment.

Layer 17 is closed-celled foam of polyethylene and ethylene vinyl acetate copolymer. Layer 17 has a thickness of between 1 mm and 5 mm, and preferably a thickness of 3 mm. Layer 17 has a density in the range of 4 to 8 lb/ft³, and preferably a density of 6 lb/ft³.

Layer 20 is of the same structure and composition as layer 14.

Layer 23 is closed-cell polyethylene foam, and acts as the core of Board 1. Core 23 has a thickness of between 0.2 inch and 2.5 inches and preferably a thickness of 1 inch. Core 23 has a density in the range of 1.6 to 4 lb/ft³, and preferably a density of 2.2 lb/ft³. It is contemplated that core 23 may be formed from two or more layers laminated together.

Layer 26 is polyethylene film. Layer 26 has a thickness of between 0.2 and 1.5 mm, and preferably a thickness of 0.5 mm.

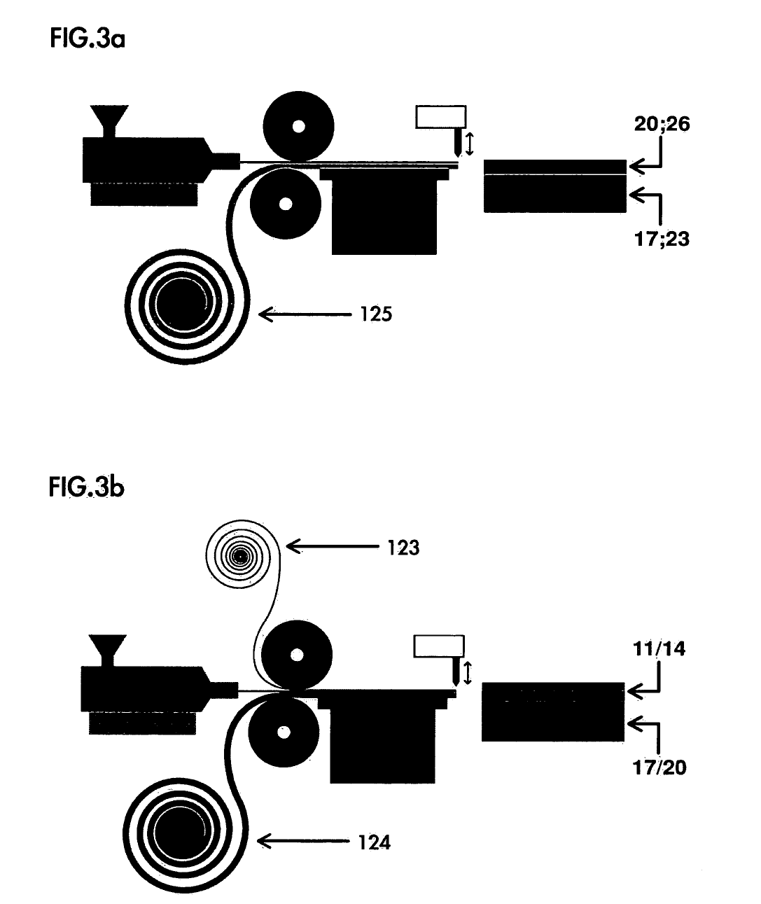

As shown in FIG. 3b, the ethylene based octene plastomer 14 in this embodiment, as well as the following embodiments, fills in the gaps between the peaks and valleys of each of the opposed surfaces of the two adjacent layers 11 and 17 to have intimate contact and better bonding.

FIG. 2b shows a second embodiment Board 2. In this embodiment, Board 2 has seven layers rather than six. The construction of embodiment 2 is the same as the embodiment 1, except the top layer. In this embodiment, the top graphic film comprises an outer polyolefin film layer 8 having an outer surface 7 and inner surface 9, and having a graphic images printed on said inner surface 9; and an inner polyolefin film layer 11 having an outer surface 10 and inner surface 12. Layer 8 has a thickness of between 0.02 mm and 0.15 and layer 11 has a thickness of between 0.01 mm and 0.15 mm.

Board 1 is formed in a series of steps. First, layer 11 is imprinted with the desired graphics using a conventional imprinting procedure. With reference to FIG. 3a, foam layer 17 is unrolled from a bottom roll 125 and hot plastomer 20 is extruded and with pressure is applied to surface 21 of layer 20 to form a laminate layer 17/20. The plastomer film 20 is heat laminated to polyethylene and ethylene vinyl acetate copolymer foam layer 17 at a temperature generally in the range 198 degree to 260 degree Fahrenheit. As shown in FIG. 3b, laminate layer 17/20 is then fed from a bottom roll 124 and layer 11 is fed from top roll 123. As Laminate layer 17/20 and Layer 11 are fed from rolls 124 and 123, respectively, layer 14 is extruded, using a conventional extrusion process, between surface 12 of layer 11 and surface 16 of layer 17 to form a top laminate of layers 11, 14, 17 and 20. The plastomer film layer 14 is heat laminated to polyethylene and ethylene vinyl acetate copolymer foam layer 17 and polyolefin film layer 11 at a temperature generally in the range 198 degree to 330 degree Fahrenheit. This laminated sheet is then cut and configured to the desired shape and size.

As shown in FIG. 3a, core 23 is fed from a bottom roll 125 and hot polyethylene film Layer 26 is extruded and with pressure is applied to surface 27 of core 26 to form a laminated layer 23/26. Laminated layer 23/26 is then shaped to form the desired front, tail and side rails configurations.

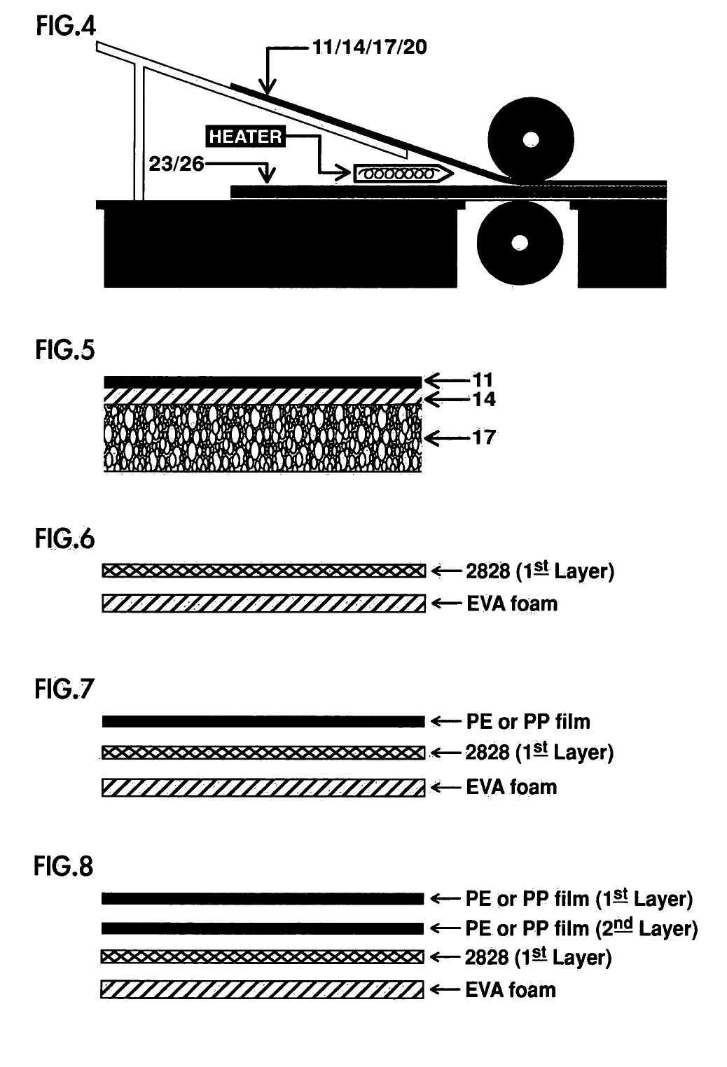

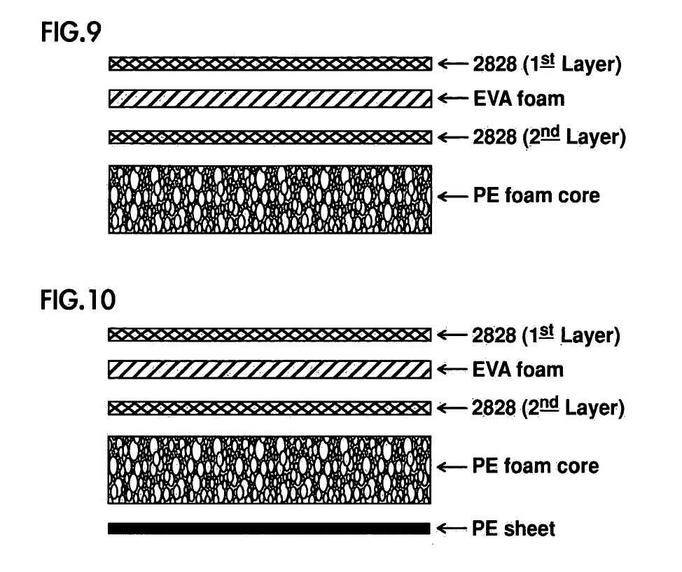

As shown is FIG. 4, the top laminate of layers 11/14/17/20 are then heat laminated to the top surface of the core 23 of the laminated Layer 23/26. The outer portions of the top laminate are then wrapped over and heat laminated to the side edges of front, tail and side rails. Excess is then trimmed as necessary, completing the covering of the side surfaces of Board 1.

1. A multi-Layered foam composite glider, comprising
a foam sheet comprising a copolymer of polyethylene and ethylene acetate; and
a first intermediate polymer film layer comprising an ethylene based octene plastomer.

2. The composite glider of claim 1, wherein said foam sheet comprises a polyethylene blended with about 1% to 25% of an ethylene vinyl acetate polymer, having a density ranging from about 3 to about 8 lb/ft³.

3. The composite glider of claim 1, wherein said first intermediate film layer comprises an ethylene based octene plastomer having a density ranging from about 0.84 to about 0.94 g/cm³.

4. The composite glider of claim 1, further including a polyolefin film layer comprising olefin polymer selected from the group consisting of polyethylene, polypropylene and a blend of polyethylene with about 1% to 10% ethylene vinyl acetate, and bonded to said first polymer film layer.

5. The composite glider of claim 4, wherein
said foam sheet has a thickness ranging from about 1 to 5 mm;
said first intermediate polymer film layer has a thickness ranging from about 0.02 to about 0.12 mm; and
said polyolefin film layer has a thickness ranging from about 0.02 to about 0.15 mm.

6. The composite glider of claim 4, wherein said polyolefin film layer further comprises:
an outer non-opaque film layer having an outer surface and inner surface, and having a graphic image printed on said inner surface of said second outer film Layer;
an inner film layer having an outer surface and inner surface; and
said outer surface of said inner film bonded with said inner surface of said outer film, said inner surface of said inner film bonded with said first intermediate polymer film layer.

7. The composite glider of claim 6, wherein
said outer film layer has a thickness ranging from about 0.02 to about 0.15 mm; and
said inner film layer has a thickness ranging from about 0.01 to about 0.15 mm.

8. The composite glider of claim 1, further including
a second intermediate polymer film layer bonded to said foam sheet, and said second intermediate polymer film layer comprises an ethylene based octene plastomer having a density ranging from about 0.84 to about 0.94 g/cm³; and
a polyethylene foam core comprising polyethylene having a density ranging from about 1.6 to about 4 lb/ft³ and bonded to said second intermediate polymer film layer.

9. The composite glider of claim 8, wherein
said foam sheet has a thickness ranging from about 1 to about 5 mm;
said first intermediate polymer film layer has a thickness ranging from about 0.02 to about 0.12 mm;
said second intermediate polymer film layer has a thickness ranging from about 0.02 to about 0.12 mm; and
said polyethylene foam core has a thickness ranging from about 0.2 to about 2.5 inches.

10. The composite glider of claim 8, further including a polyethylene film layer comprising a polyethylene selected from the group consisting of low-density polyethylene, high-density polyethylene, a blend of polyethylene with about 1% to 10% ethylene vinyl acetate and a blend of high-density polyethylene with about 10% to 40% low-density polyethylene, and bonded to said second polymer foam sheet; wherein said polyethylene film layer has a thickness ranging from about 0.3 to about 1.5 mm.

11. A method of improving surface smoothness of a graphic imprinted polyolefin film on a polyethylene foam core glider comprising:
providing a laminated skin for application to the foam core by the following steps;
providing a graphic imprinted polyolefin film layer having a thickness generally in the range of about 0.02 to about 0.3 mm;
providing a foam sheet of polyethylene and ethylene vinyl acetate copolymer having a thickness generally in the range of about 1 to about 5 mm;
extruding conventionally a first intermediate polymer film layer of an ethylene based octene plastomer having a thickness generally in the range of about 0.02 to about 0.12 mm, and heat laminated with rollers to the surface of foam sheet to form a two-layered laminate;
extruding conventionally a second intermediate polymer film layer of an ethylene based octene plastomer having a thickness generally in the range of about 0.02 to about 0.12 mm, between the polyolefin film layer and the foam sheet layer of the resulting two-layered laminate from the previous step, and heat laminated under the pressure of nip rollers to produce a four-layered laminated skin;
providing a polyethylene foam core having a thickness generally in the range of 0.2 to 2.5 inches; and
bonding the laminated skin provided in the aforementioned steps to the foam core by using a conventional heat lamination process.

12. The method of claim 11, wherein the graphic imprinted polyolefin film layer further comprises:
an outer non-opaque polyolefin film layer having a thickness generally in the range of about 0.02 to about 0.15 mm, and having a graphic image printed on its inner surface; and
an inner polyolefin film layer having a thickness generally in the range of about 0.01 to about 0.15 mm; said outer film bonded with said inner film, said inner film bonded with said first intermediate polymer film Layer.

13. The method of claim 11, wherein the polyethylene and ethylene vinyl acetate copolymer foam sheet has an average foam density of between about 3 and 8 lb/ft³.

14. The method of claim 11, wherein the polyethylene foam core has an average foam density of between about 1.6 and 4 lb/ft³.

19. 15. The method of claim 11, wherein the ethylene based octene plastomer is heat laminated to polyethylene and ethylene vinyl acetate copolymer foam sheet and polyolefin film layer at a temperature generally in the range 198 degree to 330 degree Fahrenheit.
